(19) United States
(12) Patent Application Publication
(10) Pub. No.: US 2026/0094483 A1
(43) Pub. Date: Apr. 2, 2026

(54) SYSTEMS AND METHODS FOR PRESENTING A RANDOMIZED LOTTERY GAME

(71) Applicant: Amuse d.o.o., Ljubljana (SI)

(72) Inventors: Rok KOKORAVEC, Grgar (SI); Jan Cvijanovic HUDOKLIN, Stahovica (SI); Bojan ROTAR, Ljubljana (SI); Aleksander ZUPANC, Šmarca (SI)

(21) Appl. No.: 19/342,400

(22) Filed: Sep. 26, 2025

Related U.S. Application Data
(60) Provisional application No. 63/702,031, filed on Oct. 1, 2024.

(51) Int. Cl. G07C 15/00

(52) U.S. Cl. CPC G07C 15/001

(57) ABSTRACT

A lottery game comprises a hollow canister, game pieces, a presentation mechanism, and a computing device. The computing device causes the game pieces to mix in the hollow canister. A first game piece is moved from the hollow canister to the presentation mechanism via a tube. The presentation mechanism comprises a first disk and a second disk, each with a plurality of holding cylinders. The first disk rotates to align a first holding cylinder with the tube, and the first holding cylinder accepts the first game piece. A second game piece is moved from the hollow canister to the presentation mechanism via the tube. The second disk rotates to align a second holding cylinder with the tube, and the second holding cylinder accepts the second game piece. The computing device determines a first identity of the first game piece and a second identity of the second game piece.

### CROSS REFERENCE TO RELATED APPLICATIONS

This application claims benefit under 35 U.S.C. § 119(e) of Provisional U.S. Patent Application No. 63/702,031, filed Oct. 1, 2024, the contents of which is incorporated herein by reference in its entirety.

### TECHNICAL FIELD

The present disclosure relates generally to the field of gaming, primarily to randomized lottery games.

### BACKGROUND

Casinos offer a broad range of games and experiences to provide an exciting atmosphere to attract and maintain user interest. Casinos traditionally offer physical games, including card games, dice games, table games, slot games, lottery games, and sports betting games. Such games have been re-imagined with digital capabilities, both with the capability of integrating digital features to the physical games themselves, to fully digitize the physical games, or to broadcast the games to audiences not physically on-site. Users may participate with any number of physical or digital games individually or in groups.

New games and new systems for existing games are in constant production in order to provide new experiences to users to maintain excitement and engagement. Users may be interested in automatically occurring games that do not require manual input from dealers or other employees of the casino. Automatically occurring games may be desirable to users that want to participate in a game on a recurring basis.

### SUMMARY

An embodiment is directed to a method for operating a lottery game. A computing device may cause a plurality of game pieces, located inside a hollow canister, to be continuously mixed for a first period of time. The computing device may cause movement, based on an indication to begin a game, of a first game piece from the hollow canister to a presentation mechanism via a tube connecting the hollow canister and the presentation mechanism, wherein the presentation mechanism comprises a first disk and a second disk, and wherein each disk comprises a plurality of game piece holding cylinders. The computing device may cause a first rotation of the first disk and the second disk, in which a first game piece holding cylinder of the first disk is aligned with the tube and, based on the first rotation, the first game piece is moved into the first game piece holding cylinder. Movement of a second game piece from the hollow canister to the presentation mechanism via the tube may be caused. Second rotation of the first disk and the second disk may occur, in which a second game piece holding cylinder of the second disk is aligned with the tube and, based on the second rotation, the second game piece is moved into the second game piece holding cylinder. The computing device may determine, based on identifiers of the first and second game pieces, a first identity of the first game piece and a second identity of the second game piece.

These and other features will be more clearly understood from the following detailed description taken in conjunction with the accompanying drawings and claims. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a cut-away view of a lottery game, in accordance with an embodiment.

FIG. 2 is a close-up view of a portion of a lottery game, in accordance with an embodiment.

FIG. 3 is a close-up view of a portion of a lottery game, in accordance with an embodiment.

FIG. 4 is a perspective view of a portion of a lottery game, in accordance with an embodiment.

FIG. 5 is a cut-away view of a portion of a lottery game, in accordance with an embodiment.

FIG. 6 is a flow chart of an example method of operating a lottery game, in accordance with an embodiment.

FIG. 7 is an example of a computing system, in accordance with an embodiment.

### DETAILED DESCRIPTION OF EMBODIMENTS

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

Disclosed herein are systems and methods for presenting a lottery type game for users to play. The disclosure is generally related to a bingo style game, in which a plurality of game pieces, for example bingo balls, are mixed in a mixing drum. One or more of the balls may be drawn and revealed to the users in the drawn order. Users may win the game based on predictions or other wagers regarding an upcoming drawing of the game pieces. The system may comprise an inner drum holding the plurality of balls, a presentation mechanism configured to present one or more of the plurality of balls for identification, a tube connecting the inner drum and the presentation mechanism, and a computing device configured to operate the game and display results of the game to the users. The balls drawn for a particular game may be reintroduced to the inner drum via return tubes and drawn again in a future game. One or more portions of the device may be encapsulated in an outer display device. For example, the inner drum, presentation mechanism, and tubes may be encapsulated in an outer drum. The outer drum may hide mechanical portions of the portions of the game device and to highlight aesthetically pleasing portions of the game device. The outer drum may comprise one or more display screens or display devices that present information about the game. For example, information about each drawn ball may be presented on a display screen of the outer drum as each drawn ball is identified. The game device may comprise a base. The base may house certain portions of the game device, for example an air blowing system that may be used to mix the balls in the inner drum and to transport individual balls through the tube to the presentation mechanism. The base may comprise one or more lockable wheels, and the entire game device may be selectively mobile. The lottery game may be viewed and played by users in a vicinity of the game device, and the lottery game may be viewed and played by users located remotely from the game device.

The game device may comprise one or more integrated cameras to provide live video images of the lottery game. The cameras may provide live images to be displayed on or around the game device, or the cameras may provide the live images to be transmitted to users viewing the game remotely and/or at player stations. The game device may be partially manually operated, fully manually operated, or fully automatically operated. The game device may comprise hardware that supports the lottery games. The hardware may comprise elements to facilitate the automatic or manual implementation of the drawing, identifying, and displaying of information about the drawn balls. The hardware may comprise computer hardware used to implement software for management and transmission of the game.

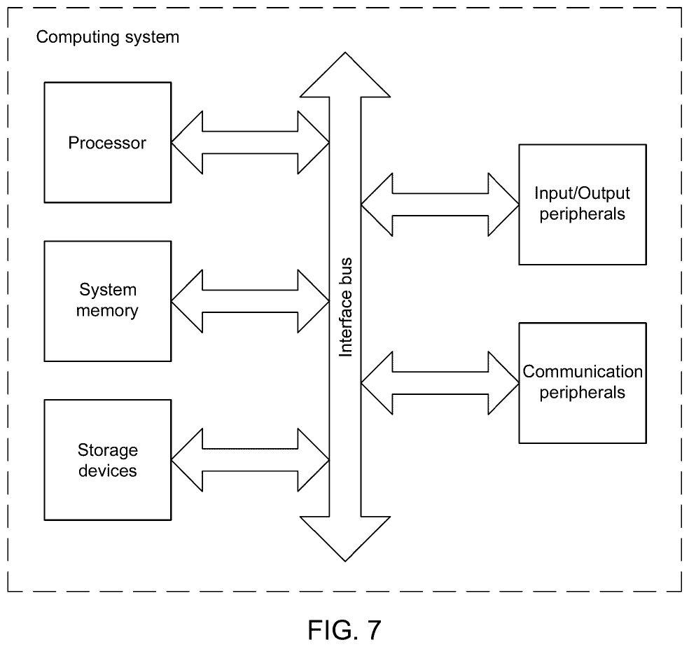

The cameras may be controlled by software of the computing system, such as that shown in FIG. 7, associated with the game device. The computing system hardware and software may be fully integrated into the game device, or the computing system may be partially integrated into the game device and partially elsewhere. For example, a server device may be implemented to manage transmission of video images and other information about the lottery game to users located remotely from the marble racing device or to player stations connected to the game. The game may be livestreamed to the remote users and to the player stations connected to the game. The server may implement a host system to electronically manage the device and/or the livestreaming of the game to audiences. The server may manage wagers and predictions made by users participating in the game.

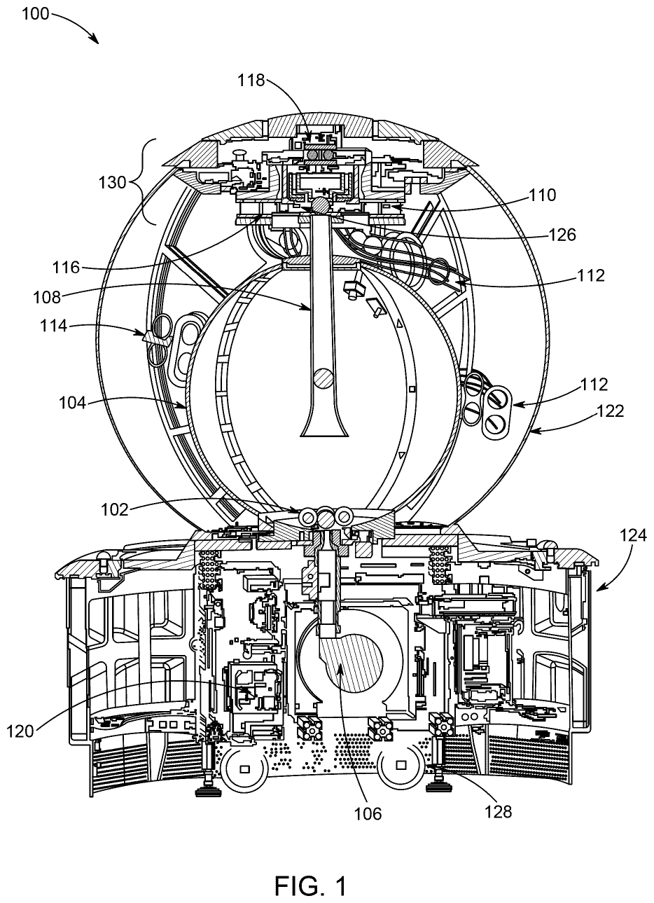

FIG. 1 shows a cut-away view of an example lottery game 100. The device may comprise a plurality of game pieces 102, e.g., balls, to be used in the game. For example, the inner drum 104 may hold anywhere from one to 100 balls 102 or more. Each ball 102 may be associated with an identifier. For example, each ball 102 may be associated with a number, each ball 102 may be associated with a letter, each ball 102 may be associated with a color, each ball 102 may be associated with a symbol, or the like. The balls 102 may be associated with multiple identifiers. For example, a ball 102 may be associated with a number and a letter, or a number/letter and a color. The ball 102 may be the only ball associated with a particular number, but the ball 102 may be one of a plurality of balls associated with a particular letter, or vice versa. The balls 102 may have one or more identifiers that are not visible to a human eye. For example, the balls 102 may comprise radio frequency identification (RFID) tags. The RFID tags may be readable by an RFID sensor, for example sensor 116. The balls 102 may comprise both visible and invisible identifiers. For example, a number, a letter, a color, or the like may be printed on the balls 102, and an RFID tag may be contained in the balls 102.

The balls 102 may be held in an inner drum 104, which may be a sphere, a cylinder, a box, or the like. The system may return all balls 102 to the inner drum 104 and initiate a new game. The balls 102 may be mixed within the inner drum to randomize an order of the balls 102. The mixing may occur by an air flow system 106 that blows air into the inner drum 104 and causes the balls 102 to move around and mix within the inner drum 104. Proper mixing of the balls 102 ensures actual randomization of which game pieces are drawn from game to game, which may be a requirement for operating the game.

A tube 108 may protrude into an inside of the inner drum, and the tube 108 may have a diameter similar to a diameter of the balls 102. The tube 108 may accept individual balls in a first, open end 108a of the tube protruding into the inner drum 104. The first, open end 108a may have a conical opening designed to encourage balls that come into contact with the open end 108a of the tube to ricochet or guide farther up and into the tube, rather than bouncing back down into the inner drum. Balls may travel up the tube 108 from the open end 108a, driven by air flow from the air flow system 106 to a second, upper opening 108b. The upper opening 108b of the tube 108 may be coupled to a ball identification system 130, and the upper opening 108b of the tube 108 may be closed off in a first configuration. The closed off configuration may prevent the ball from passing from the tube 108 to the ball identification system 130. The ball identification system 130 may comprise, for example, an antenna configured to detect that a ball has entered the tube 108. Based on determining the ball has entered the tube 108 and is available, the ball identification system 130 may initiate an operation to change the closed off configuration to an open configuration to allow the ball to pass into the ball identification system 130.

The ball identification system 130 may comprise one, two, or more disks 110. In a particular configuration, the ball identification system 130 may comprise two disks 110. The two disks may be situated side-by-side. Each disk may comprise one or more lobes, and each lobe may comprise a cylinder 126 for accepting a game piece 102. The tube 110 may have a second end that extends out of the inner drum 104 and couples to a central portion of the ball identification system 130. Each disk 110 may be rotatable on an axis of rotation that is substantially parallel with the tube 108. The axis of rotation of each disk 110 may be laterally offset from the center of the tube 108. A first disk 110 may rotate such that, in a first position, a first lobe of the first disk (and by extension a cylinder of the first lobe) may not be aligned with the upper opening 108b of the tube 108. In the configuration in which a cylinder is not aligned with the upper opening 108b of the tube 108, the upper opening 108b of the tube 108 may be capped, preventing air from flowing through the tube 108 from the inner drum 104 to the ball identification system 130. The first disk 110 may be rotated such that, in a second position, the first lobe of the first disk (and by extension the cylinder of the first lobe) is aligned with the upper opening 108b of the tube 108. In the configuration in which a cylinder is aligned with the upper opening 108b of the tube 108, the upper opening 108b of the tube 108 may be free to pass air from the inner drum 104, through the tube 108, and into the cylinder of the first disk 110. The first disk 110 may rotate, causing the cylinder to no longer be aligned with the tube 108, but the ball 102 is inside the cylinder. The first disk 110 may rotate far enough that a sensor 116 may read an identity of the ball 102 captured within the cylinder. For example, the sensor 116 may be an RFID sensor and may read an identity associated with an RFID tag of the ball 102 captured in the cylinder. The RFID sensor may be in communication with a computing device 120 of the system, and the computing device may store an indication of the identifier of the ball 102.

The first disk and the second disk 110 may rotate synchronously. For example, the first disk and the second disk may rotate a same amount. The first disk and the second disk may be coupled to a same motor 118 to ensure the first disk and the second disk rotate synchronously. The first disk, with a first ball 102 captured in the cylinder of the first lobe, may rotate away from alignment with the tube 108. Synchronously, the second disk may rotate such that no lobes of the second disk are aligned with the tube 108, and the upper opening of the tube 108 may be capped to prevent air flow from the inner drum 104 through the tube 108 and into the ball identification system 130. The ball identification system 130 may rotate further, causing the first disk and the second disk to rotate synchronously. The second lobe (comprising a second cylinder) of the second disk may be rotated into alignment with the upper opening 108b of the tube 108, and air flow may be able to pass through the tube 108 into the ball identification system 130. A second ball 102 may be forced by the air into the tube 108 and up into the aligned second cylinder of the second lobe of the second disk 110. The first disk and the second disk may rotate, moving the second lobe of the second disk out of alignment with the upper opening 108b of the tube 108. The rotation of the second lobe, with the second ball 102 captured within the second cylinder, may cause the second ball to pass within a sensor range of a sensor 116 associated with the second disk. The sensor 116 associated with the second disk may read an identity of the second ball 102. The sensor 116 associated with the second disk may read an RFID tag of the second ball 102. The sensor 116 associated with the second disk may send the sensed identity of the second ball to the computing device 120 of the system, and the computing device may store an indication of the identifier of the second ball 102.

The first disk may rotate to a point where the cylinder of the first lobe of the first disk is aligned with a return track 112. The return track 112 may comprise a diameter similar to the ball 102, and the ball 102 may fall out of the cylinder and into the return track 112. The ball may travel along the return track 112 and eventually be returned to the inner drum 104. The return track 112 may comprise a series of rails that act as a guide for the ball 102 to travel back toward an inlet into the inner drum 104, or the return track 112 may be a tube, similar to tube 108. Though shown in the cut-away FIG. 1 as only partial sections, the return track 112 is a continuous track running from the first disk to the return inlet to the inner drum 104. The return track 112 may be equipped with one or more vibrating mechanisms 114 to vibrate the return track 112 and facilitate movement of the balls 102 travelling on the return track 112. The one or more vibration mechanisms 114 may be spaced evenly along the return track 112 or placed at specific points along the return track 112 that are prone to causing the balls 102 to become stuck. The vibration mechanism 114 can dislodge balls that are stuck along the return track 112.

The second disk may rotate to a point where the cylinder of the second lobe of the second disk is aligned with a return track 112. The return track 112 may comprise a diameter similar to the balls 102, and the second ball 102 may fall out of the cylinder and into the return track 112. The second ball may travel along the return track 112 and eventually be returned to the inner drum 104. The return track 112 may comprise a series of rails that act as a guide for the second ball 102 to travel back toward an inlet into the inner drum 104, or the return track 112 may be a tube, similar to tube 108. Though shown in the cut-away FIG. 1 as only partial sections, the return track 112 may be a continuous track running from the first disk to the return inlet to the inner drum 104. The return track 112 may be equipped with one or more vibrating mechanisms 114 to vibrate the return track 112 and facilitate movement of the balls 102 travelling on the return track 112. The one or more vibration mechanisms 114 may be spaced evenly along the return track 112 or placed at specific points along the return track 112 that are prone to causing the balls 102 to become stuck. The vibration mechanism 114 can dislodge balls that are stuck along the return track 112.

The game system may be encapsulated in an outer drum 122 which may hide mechanical portions of the game system and display aesthetically pleasing elements of the game system. The outer drum 122 may be partially or fully transparent or opaque. The outer drum 122 may be partially or fully covered in one or more display screens. The one or more display screens may comprise light-emitting diodes (LEDs) to display video images associated with the game. For example, the LEDs of the outer drum 122 may display video images of a ball being drawn and placed into a position of a game board. The LEDs of the outer drum 122 may display the outcome of the games. The outer drum 122 may display the outcome of wagers or predictions made by users participating in the games. The game system may be situated on a base 124 that is designed to encapsulate portions of the game mechanisms and provide a stable housing for the game system. The base may comprise the air flow system 106, and the base 124 may comprise the computing system 120 of the game system. The base 124, like the outer drum 122, may also be covered, partially or fully, in display screens, such as LEDs. The display screens may work separately or in concert with display screens of the outer drum 122 to display video images associated with the game system. The entire apparatus may be selectively mobile. For example, an underside of the base 124 may comprise one or more wheels 128. The wheels 128 may be useful to move the game system from one location to another, and the wheels 128 may be locked in place at a destination of the game system.

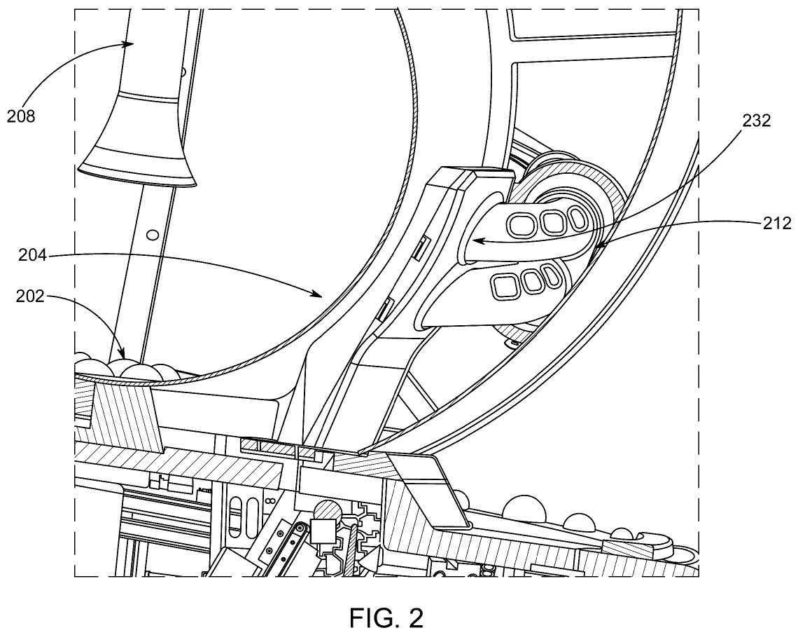

FIG. 2 shows a close-up view of a portion of a game system. The view shows a plurality of balls 202 used in the game. For example, the inner drum 204 may hold anywhere from one to 100 balls 202 or more. Each ball 202 may be associated with an identifier. For example, each ball 202 may be associated with a number, each ball 202 may be associated with a letter, each ball 202 may be associated with a color, each ball 202 may be associated with a symbol, or the like. The balls 202 may be associated with multiple identifiers. For example, a ball 202 may be associated with a number and a letter or a number/letter and a color. The ball 202 may be the only ball associated with a particular number, but the ball 202 may be one of a plurality of balls associated with a particular letter, or vice versa. The balls 202 may have one or more identifiers that are not visible to a human eye. For example, the balls 202 may comprise RFID tags. The RFID tags may be readable by an RFID sensor. The balls 202 may comprise both visible and invisible identifiers. For example, a number, a letter, a color, or the like may be printed on the balls 202, and an RFID tag may be contained in the balls 202.

The balls 202 may be held in an inner drum 204, which may be a sphere, a cylinder, a box, or the like. The system may return all balls 202 to the inner drum 204 after each game is complete and initiate a new game with the full set of balls 202. The balls 202 may be mixed within the inner drum 204 to randomize an order of the balls 202. Proper mixing of the balls 202 ensures randomization of which balls 202 are drawn each game, which may be a requirement for operating the game. As described in FIG. 1, the balls 202 may be forced into the tube 208, for example using an air flow system, and the balls 202 may travel through the tube 208 and into a ball identification system. The ball identification system may identify which balls 202 are passing through the ball identification system and determine an outcome of a game based on the order. The balls 202 may pass from an outlet of the ball identification system to one or more return tracks 212. In FIG. 2, the return track 212 is shown as two stacked return tracks 212. For example, a first ball exiting a cylinder of a first disk of the ball identification system may pass into a first return track and travel along the first return track to a first inlet gate 232 of the inner drum 204. For example, a second ball exiting a cylinder of a second disk of the ball identification system may pass into a second return track and travel along the second return track to a second inlet gate 232 of the inner drum 204. However, the game system may be constructed with a single return track 212. For example, the first ball may be released from the cylinder of the first disk into a first portion of track, and the second ball may be released from the cylinder of the second disk into a second portion of track, and the first portion of track and the second portion of track may both be coupled to a single return track 212. The single return track 212 in the example may return the first ball and the second ball to the inlet gate 232 of the inner drum 204. The inlet gate 232 may be selectively opened. For example, the inlet gate 232 may be closed during an active game to prevent air from the air flow system from entering the return track 212. The inlet gate 232 may be opened selectively to return the balls used in a game to the inner drum 204 so a new game may be started with all balls 202 present for randomization and possible selection.

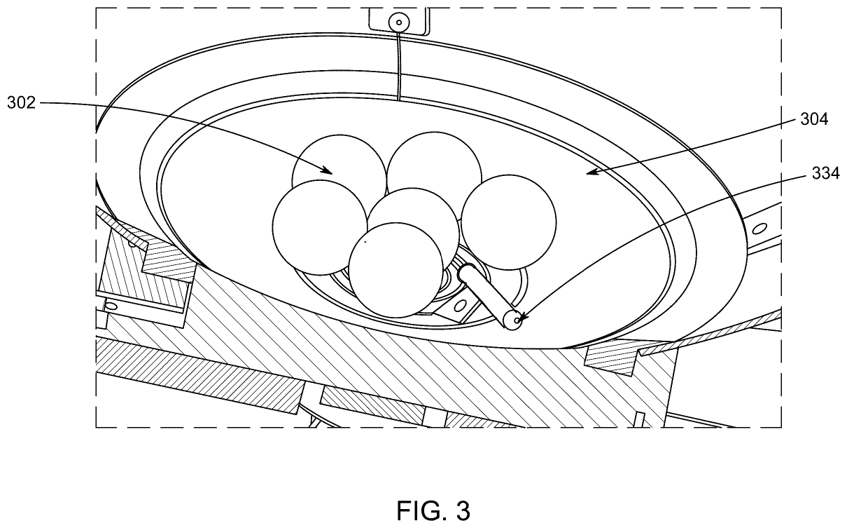

FIG. 3 shows a close-up view of a portion of the game system described in FIGS. 1 and 2. For example, FIG. 3 shows a view of a bottom of the inner drum 304. The bottom of the drum shows a collection of balls 302 near a bottom of the inner drum 304. The balls may be stationary. It may be desirable to mix the balls 302 to ensure randomization of the balls 302 for gameplay. The balls 302 may be sufficiently mixed using the air flow system described in FIG. 1, in which air is forced into a bottom portion of the inner drum 304 to cause the balls 302 to be blown away from the bottom of the inner drum 304. However, using only an air flow system may not introduce a desired level of randomness. To add additional mixing of the balls 302, a mixing stick 334 may be incorporated into the game system. The mixing stick 334 may be coupled to a rotatable portion of the bottom of the inner drum 304, and the mixing stick be rotated about the bottom portion of the inner drum 304. The rotation of the mixing stick 334 may cause interference with balls 302 at rest near the bottom of the inner drum 304 and cause the balls impacted by the rotating mixing stick 334 to be mixed more than simply by using an air flow system.

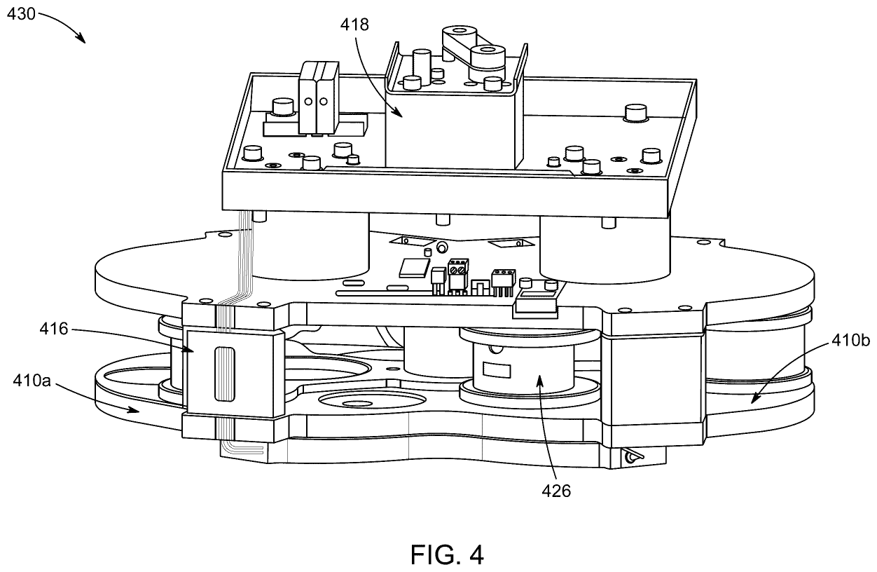

FIG. 4 shows an example close-up view of the ball identification system 430 described, for example, in FIG. 1. The ball identification system 430 is generally configured to accept a ball from an inner drum of the game system via a tube and identify the ball for use during the game. Disks 410a and 410b may each comprise a plurality of cylinders 426. The disks 410a and 410b may be rotated to align one of the plurality of cylinders with the tube. As a cylinder 426 is aligned with the tube, air may be forced through the tube and into the cylinder, driving a ball through the tube and into the cylinder 426 aligned with the tube. For example, the ball may be driven into a first cylinder 426 associated with the first disk 410a. The first disk 410a may be rotated such that the first cylinder holding the first ball moves out of alignment with the tube, causing the tube to be capped and restricting airflow through the tube. The first disk 410a may rotate past a ball identification sensor 416, for example an RFID sensor. The ball may comprise an identification tag, for example an optical reader or an RFID tag, and the sensor 416 may determine an identity of the first ball via optical recognition or the RFID tag associated with the ball. The system may comprise a second sensor (not shown) opposite the sensor 416, and the ball may pass between the first and second sensors as the first ball moves with the rotation of the first disk 410a. The system may be configured in a manner to cause the ball to roll as the first disk 410a rotates. Based on the first sensor 416 and the second sensor, and/or based on the rolling of the first ball, the system ensures the RFID tag is identifiable by the recognition system. In a similar manner, in an embodiment that identifies the first ball via optical recognition, for example using a number printed on the ball, cameras may be fixed on opposite side of the first ball's path, and the ball may roll past the two cameras to ensure at least one of the cameras may optically recognize the identity of the first ball.

In one embodiment, the sensor 416 may be able to identify balls held in cylinders associated with the second disk 410b. However, there may be another sensor (not shown) that is in closer communication with the second disk 410b and configured to identify a ball in a cylinder of the second disk. The second disk 410b may rotate synchronously with the first disk 410a because the first disk 410a and second disk 410b may be driven by a same assembly 418. The assembly may comprise a motor and at least one belt or gear coupled to the first disk 410a and second disk 410b to drive rotation of both disks synchronously. Thus, the cylinders 426 from both disks may each be able to align with the tube at different times without a cylinder from the first disk 410a colliding with a cylinder from the second disk 410b. As a cylinder of the first disk 410a is rotated into position of alignment with the tube the cylinders of the second disk 410b are intentionally offset from alignment with the tube. Likewise, as a cylinder of the second disk 410b is rotated into position of alignment with the tube the cylinders of the first disk 410a are intentionally offset from alignment with the tube.

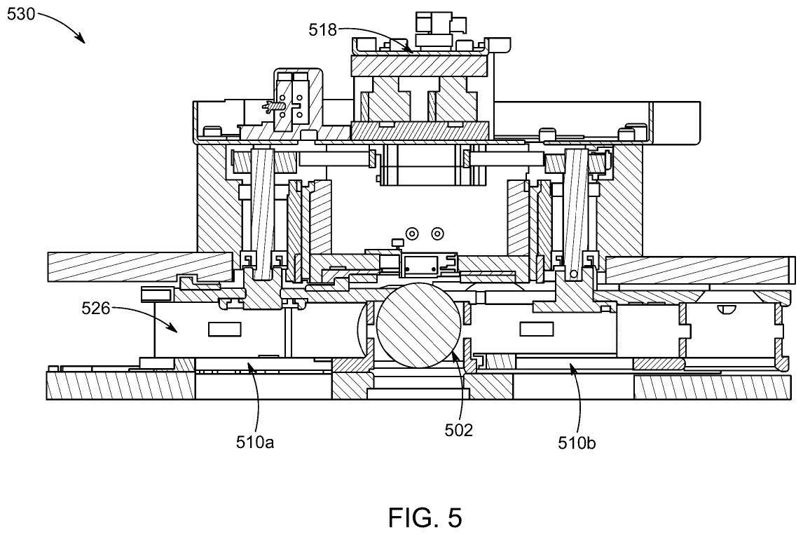

FIG. 5 shows an example cross-sectional view of the ball identification system 530, similar to the ball identification system 430 shown in FIG. 4. The ball identification system 530 is generally configured to accept a ball 502 from an inner drum of the game system via a tube and identify the ball 502 for use during the game. Disks 510a and 510b may each comprise a plurality of cylinders 526. The disks 510a and 510b may be rotated to align one of the plurality of cylinders with the tube. As a cylinder 526 is aligned with the tube, air may be forced through the tube and into the cylinder, driving the ball 502 through the tube and into the cylinder 526 aligned with the tube. For example, the ball 502 may be driven into a first cylinder 526 associated with the first disk 510a. The first disk 510a may be rotated such that the first cylinder holding a first ball moves out of alignment with the tube, causing the tube to be capped and restricting airflow through the tube. The first disk 510a may rotate past a ball identification sensor 516, for example an RFID sensor. The first ball may comprise an identification tag, for example an RFID tag, and the sensor 516 may determine an identity of the first ball via the RFID tag associated with the first ball. The sensor 516 may be able to identify balls held in cylinders associated with the second disk 510b. However, there may be a second sensor (not shown) that is in closer communication with the second disk 510b and configured to identify a ball in a cylinder of the second disk. The second disk 510b may rotate synchronously with the first disk 510a because the first disk 510a and second disk 510b may be driven by a same assembly 518. The assembly may comprise a motor and at least one belt or gear coupled to the first disk 510a and second disk 510b to drive rotation of both disks synchronously. Thus, the cylinders 526 from both disks may each be able to align with the tube at different times without a cylinder from the first disk 510a colliding with a cylinder from the second disk 510b. As a cylinder of the first disk 510a is rotated into position of alignment with the tube the cylinders of the second disk 510b are intentionally offset from alignment with the tube. Likewise, as a cylinder of the second disk 510b is rotated into position of alignment with the tube the cylinders of the first disk 510a are intentionally offset from alignment with the tube.

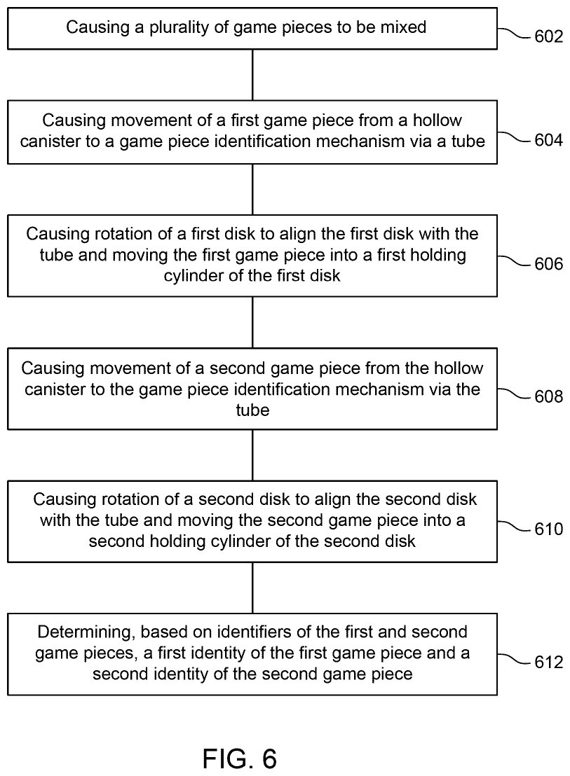

FIG. 6 provides a flowchart of a lottery game operation, in accordance with aspects of the present disclosure. The operations may be carried out by a lottery game device and system, for example game system 100. The operations may be carried out by a computing device. The computing device may be integrated into the lottery game device. The computing device may be separate from the lottery game device. For example, the computing device may be a server device configured to communicate with components of the lottery game device. The computing device may execute instructions that cause the actions described in FIG. 6.

At block 602, a plurality of game pieces may be mixed. For example, the plurality of game pieces may be held within an inner drum of the game system. The inner drum may be a sphere, a box, or a cylinder. The inner drum may house between one game piece and 100 game pieces. The game pieces may be mixed by forcing air into the inner drum to cause the game pieces to be randomly moved throughout the inner drum. A mixing stick may be coupled to a bottom or side of the inner drum and rotatably move, causing collisions with one or more game pieces to cause further mixing of the game pieces.

At block 604, a game may be triggered and a first game piece may be moved from the inner drum to a game piece identification system via a tube. The tube may be open at both ends and may be partially disposed within the inner drum. The tube may have a diameter larger than a diameter of one of the game pieces but smaller than a diameter of two of the game pieces. The tube may accept one of the game pieces through a first end of the tube and transport the game piece to the game piece identification system in communication with the other open end of the tube.

At block 606, a first disk of the game piece identification system may be rotated to align a cylinder of the first disk with an upper opening of the tube. The cylinder may have a diameter substantially similar to the diameter of the tube. The first disk may comprise a plurality of cylinders situated evenly around a circumference of the first disk. The air flow used to mix the game pieces in the inner drum may force the game piece from the tube into the cylinder of the first disk. The cylinder of the first disk may hold the game piece for identification.

At block 608, a second game piece may be moved from the inner drum to the game piece identification system via the tube. The tube may be open at both ends and may be partially disposed within the inner drum. The tube may have a diameter larger than a diameter of one of the game pieces but smaller than a diameter of two of the game pieces. The tube may accept a second one of the game pieces through the first end of the tube and transport the second game piece to the game piece identification system in communication with the other open end of the tube. The second game piece may comprise a different identity than the first game piece held in the cylinder of the first disk.

At block 610, a second disk of the game piece identification system may be rotated to align a cylinder of the second disk with the upper opening of the tube. The cylinder of the second disk may have a diameter substantially similar to the diameter of the tube and the cylinder of the first disk. The second disk may comprise a plurality of cylinders situated evenly around a circumference of the second disk. The air flow used to mix the game pieces in the inner drum may force the second game piece from the tube into the cylinder of the second disk. The cylinder of the second disk may hold the second game piece for identification.

At block 612, the first disk may rotate past a game piece identification sensor. The game piece identification sensor may sense an identity associated with the first game piece. For example, the first game piece may comprise an RFID tag, and the game piece identification sensor may sense the identity of the first game piece using the RFID tag. The second disk may rotate past a second game piece identification sensor. The second game piece identification sensor may sense an identity associated with the second game piece. For example, the second game piece may comprise an RFID tag, and the second game piece identification sensor may sense the identity of the second game piece using the RFID tag. The first disk and the second disk may alternatively be associated with a single game piece identification sensor configured to sense an identity associated with game pieces held within cylinders of both the first disk and the second disk.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The techniques described above can be implemented on a computing device associated with a game (e.g., a bingo game or other lottery game), a plurality of computing devices associated with a plurality of games, a controller in communication with the game(s) (e.g., a controller configured to synchronize the game(s)), or a plurality of controllers in communication with the game(s), such as a GANLOT AMDY-7005, which is designed for gaming applications. The controller module may also provide outputs for the game's lighting, operations, and automated functions.

Additionally, the techniques may be distributed between the computing device(s) and the controller(s). FIG. 7 illustrates an exemplary block diagram of a computing system or game server, for games and player stations, which includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the roulette wheel velocity adjustments and result detection optimization, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a Wi-Fi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile, or non-volatile storage.

In an embodiment, a system for operation of a lottery game comprises a hollow canister, a plurality of game pieces, a game piece identification mechanism, and a computing device configured to operate the lottery game. The computing device causes the plurality of game pieces, located inside the hollow canister, to be continuously mixed for a first period of time. The computing device causes movement, based on an indication to begin a game, of a first game piece from the hollow canister to the game piece identification mechanism via a tube connecting the hollow canister and the game piece identification mechanism, wherein the game piece identification mechanism comprises a first disk and a second disk, and wherein each disk comprises a plurality of game piece holding cylinders. The computing device causes a first rotation of the first disk and the second disk, in which a first game piece holding cylinder of the first disk is aligned with the tube and, based on the first rotation, the first game piece is moved into the first game piece holding cylinder. The computing device may cause movement of a second game piece from the hollow canister to the game piece identification mechanism via the tube. The computing device causes a second rotation of the first disk and the second disk, in which a second game piece holding cylinder of the second disk is aligned with the tube and, based on the second rotation, the second game piece is moved into the second game piece holding cylinder. The computing device determines, based on identifiers of the first and second game pieces, a first identity of the first game piece and a second identity of the second game piece.

In the embodiment, wherein the hollow canister is substantially spherical.

In the embodiment, wherein each game piece is a ball.

In the embodiment, wherein the identifiers comprise radio frequency identification (RFID) tags.

In the embodiment, wherein the computing device is further configured to present, based on the determination of the first identity and the second identity, the first identity and the second identity on a display.

In the embodiment, wherein the tube is a first tube and the computing device is further configured to cause ejection, based on the determining the first identity, the first game piece into a second tube, and cause ejection, based on the determining the second identity, the second game piece into a third tube.

In the embodiment, wherein the second tube and the third tube are each coupled to one or more vibration mechanisms to facilitate movement of game pieces through the second tube and the third tube.

In the embodiment, further comprising reintroducing, based on a determination to begin another game, the first game piece and the second game piece to the hollow canister.

In the embodiment, wherein air is blown in the hollow canister to cause mixing of the plurality of game pieces, and wherein the air causes the first game piece and the second game piece to travel through the tube.

In the embodiment, wherein the hollow canister further comprises a mixing stick rotating within the hollow canister to cause mixing of the plurality of game pieces.

What is claimed is:

1. A system comprising:
a hollow canister;
a plurality of game pieces;
a game piece identification mechanism; and
a computing device configured to:
cause the plurality of game pieces, located inside the hollow canister, to be continuously mixed for a first period of time;
cause movement, based on an indication to begin a game, of a first game piece from the hollow canister to an inlet of the game piece identification mechanism via a tube connecting the hollow canister and the game piece identification mechanism, wherein the game piece identification mechanism comprises a first disk and a second disk, and wherein each disk comprises a plurality of game piece holding cylinders;
cause a first rotation of the first disk and the second disk, in which a first game piece holding cylinder of the first disk is aligned with the tube and, based on the first rotation, the first game piece is moved into the first game piece holding cylinder;
cause movement of a second game piece from the hollow canister to the game piece identification mechanism via the tube;
cause a second rotation of the first disk and the second disk, in which a second game piece holding cylinder of the second disk is aligned with the tube and, based on the second rotation, the second game piece is moved into the second game piece holding cylinder;
determine, via identification sensors detecting identifiers of the first and second game pieces, a first identity of the first game piece and a second identity of the second game piece; and
send, to at least one of a second computing device associated with a player or a third computing device associated with an operator of the system, at least one of a state of a game associated with the second computing device, a result of a game associated with the first identity and the second identity, or information associated with operation of the system.

2. The system of claim 1, wherein the hollow canister is substantially spherical.

3. The system of claim 1, wherein each game piece is a ball.

4. The system of claim 1, wherein the identifiers comprise at least one of embedded radio frequency identification (RFID) tags or numbers printed on the first and second game pieces.

5. The system of claim 1, wherein the computing device is further configured to:
present, based on the determination of the first identity and the second identity, the first identity and the second identity on a display.

6. The system of claim 1, wherein the computing device is further configured to:
cause ejection, based on the determining the first identity, of the first game piece into a first outlet system; and
cause ejection, based on the determining the second identity, of the second game piece into a second outlet system.

7. The system of claim 6, wherein the first outlet system and the second outlet system are each coupled to one or more vibration mechanisms to facilitate movement of game pieces through the first outlet system and the second outlet system.

8. The system of claim 6, further comprising reintroducing, based on a determination to begin another game, the first game piece and the second game piece to the hollow canister.

9. The system of claim 1, wherein air is blown in the hollow canister to cause mixing of the plurality of game pieces, and wherein the air causes the first game piece and the second game piece to travel through a conical opening at a first end of the tube configured to re-direct game pieces into the tube.

10. The system of claim 1, wherein the hollow canister further comprises a mixing stick rotating within the hollow canister to cause mixing of the plurality of game pieces.

11. A method comprising:
causing a plurality of game pieces, located inside a hollow canister, to be continuously mixed for a first period of time;
causing movement, based on an indication to begin a game, of a first game piece from the hollow canister to a game piece identification mechanism via a tube connecting the hollow canister and the game piece identification mechanism, wherein the game piece identification mechanism comprises a first disk and a second disk, and wherein each disk comprises a plurality of game piece holding cylinders;
causing a first rotation of the first disk and the second disk, in which a first game piece holding cylinder of the first disk is aligned with the tube and, based on the first rotation, the first game piece is moved into the first game piece holding cylinder;
causing movement of a second game piece from the hollow canister to the game piece identification mechanism via the tube;
causing a second rotation of the first disk and the second disk, in which a second game piece holding cylinder of the second disk is aligned with the tube and, based on the second rotation, the second game piece is moved into the second game piece holding cylinder;
determining, via identification sensors detecting identifiers of the first and second game pieces, a first identity of the first game piece and a second identity of the second game piece; and
sending, to at least one of a computing device associated with a player or a computing device associated with an operator, at least one of a state of a game associated with the player computing device, a result of a game associated with the first identity and the second identity, or information associated with operation of the game.

12. The method of claim 11, wherein the hollow canister is substantially spherical.

13. The method of claim 11, wherein each game piece is a ball.

14. The method of claim 11, wherein the identifiers comprise at least one of embedded radio frequency identification (RFID) tags or numbers printed on the first and second game pieces.

15. The method of claim 11, further comprising:
presenting, based on the determining of the first identity and the second identity, the first identity and the second identity on a display.

16. The method of claim 11, further comprising:
causing ejection, based on the determining the first identity, the first game piece into a first outlet system; and
causing ejection, based on the determining the second identity, the second game piece into a second outlet system.

17. The method of claim 16, wherein the first outlet system and the second outlet system are each coupled to one or more vibration mechanisms.

18. The method of claim 16, further comprising reintroducing, based on a determination to begin another game, the first game piece and the second game piece to the hollow canister.

19. The method of claim 11, wherein air is blown in the hollow canister to cause mixing of the plurality of game pieces, and wherein the air causes the first game piece and the second game piece to travel through a conical opening at a first end of the tube configured to re-direct game pieces into the tube.

20. The method of claim 11, wherein the hollow canister further comprises a mixing stick rotating within the hollow canister to cause mixing of the plurality of game pieces.
